(19) United States
(12) Patent Application Publication
(10) Pub. No.: US 2021/0215095 A1
(43) Pub. Date: Jul. 15, 2021

(54) BIOMASS GASIFICATION POWER GENERATION SYSTEM AND POWER GENERATION METHOD

(71) Applicant: Mitsubishi Gas Chemical Company, Inc., Tokyo (JP)

(72) Inventors: Takeshi HIROKANE, Chiyoda-ku, Tokyo (JP); Tomoaki KIRINO, Katsushika-ku, Tokyo (JP); Ryutaro KIMURA, Katsushika-ku, Tokyo (JP)

(21) Appl. No.: 16/967,385

(22) PCT Filed: Feb. 1, 2019
(86) PCT No.: PCT/JP2019/003544

§ 371 Date: Aug. 4, 2020

(30) Foreign Application Priority Data
Feb. 5, 2018 (JP) 2018-018651
Jun. 14, 2018 (JP) 2018-113804

(51) Int. Cl. F02B 43/08; C10J 3/02; C10J 3/72; C25B 1/04; C25B 9/00

(52) U.S. Cl. CPC F02B 43/08; C10J 3/02; C10J 3/72; C25B 1/04; C25B 9/00; F02B 2201/04; C10J 2300/1684; C10J 2300/092; C10J 2300/0956; C10J 2300/0959; C10J 2300/1643; C10J 2300/1671; C10J 2300/0916

(57) ABSTRACT

A biomass gasification power generation system including: a gas generation device that generates a combustible gas from a biomass and a gasification agent; an internal combustion engine that generates motive power from a fuel gas containing the combustible gas generated by the gas generation device; and a generator that generates electric power from the motive power generated by the internal combustion engine. The power generation system is additionally provided with a water electrolysis device that generates oxygen and hydrogen through the electrolysis of water. The gasification agent contains oxygen generated by the water electrolysis device, and the fuel gas contains hydrogen generated by the water electrolysis device. The oxygen concentration in the gasification agent is from 22 vol. % to 40 vol. %.

### TECHNICAL FIELD

The present invention relates to a biomass gasification power generation system and a power generation method.

### BACKGROUND ART

A method for gasifying and using biomass, which is a biologically-derived resource, has been proposed. More specifically, when a gasification agent including air, oxygen, or water vapor, etc. is fed along with a biomass into a gasification furnace and gasified, a synthetic gas containing hydrogen, carbon monoxide, and carbon dioxide as main components is produced. The generated synthetic gas is used as a fuel for an internal combustion engine. Here, as a result of the gasification described above, by-products such as tar, which is a hydrocarbon, are typically produced simultaneously with the synthetic gas. The generation of by-products results in the occurrence of problems such as clogging of equipment and piping in the above-mentioned gasification furnace, which are caused by the produced tar and other by-products.

Patent Document 1 discloses a thermolysis gasification system provided with: a carbonization device that produces a carbonized material obtained by carbonizing biomass or organic waste at a predetermined temperature, and a thermolysis gasification device that introduces water vapor, air, and the carbonized material obtained by the carbonization device into a thermolysis gasification furnace to obtain a combustible gas. Patent Document 1 discloses that because a carbonization treatment is carried out in accordance with the characteristics of the organic waste, the generation of tar is suppressed, and combustible gas can be obtained with optimal characteristics such as a high yield, and also indicates that this combustible gas can drive a generator using an internal combustion engine as a drive source, and power can be generated on small and medium scales using a compact, inexpensive device. Patent Document 1 further discloses that oxygen enriched air produced by a pressure swing adsorption apparatus (PSA) may be introduced in place of air in order to increase the concentration of the combustible gas that is produced.

Patent Document 2 discloses a method for co-producing hydrogen and electric power, the method including: using an intermittent renewable energy source to generate energy for producing hydrogen and oxygen; transferring at least part of the energy to a production system to produce hydrogen and oxygen; directing at least part of the hydrogen to a hydrogen delivery system configured to deliver hydrogen from the hydrogen delivery system to at least one of a power generation system or a hydrogen storage system; guiding at least part of the oxygen to an oxygen delivery system configured to deliver the oxygen from the oxygen delivery system to a biomass gasification system, and producing a synthetic gas through partial oxidation of a biomass raw material; and guiding at least part of the synthetic gas to the power generation system to produce electric power therefrom.

### CITATION LIST

### Patent Documents

Patent Document 1: JP 2004-035837 A

Patent Document 2: JP 2007-525555 T

### SUMMARY OF INVENTION

### Technical Problem

However, with the thermolysis gasification system described in Patent Document 1, from the perspective of suppressing the occurrence of tar, a carbonization treatment must be performed at a high temperature of 300° C. or higher in order to achieve optimal characteristics for gasification of biomass and the like, and the energy efficiency of the entire system is not sufficient. In addition, in Patent Document 1, motive power is generated from combustible gas generated by an internal combustion engine, and the generator is driven using the generated motive power, but the motive power must be further improved in order to achieve practical application as a power generation system.

The method for co-producing hydrogen and electric power described in Patent Document 2 is not demonstrated in the examples, and the oxygen concentration of the oxygen used in the co-production method has not been examined.

Therefore, an object of the present invention is to provide a power generation system and a power generation method that can improve the yield of combustible gas when producing combustible gas from biomass, and can further improve motive power for driving a generator.

### Solution to Problem

In order to solve the problems described above, the inventors of the present invention conducted diligent research, and as a result, discovered that the above-mentioned problems can be solved by configuring a power generation system that uses biomass to generate power, such that oxygen generated by the electrolysis of water is included as a gasification agent for producing a combustible gas from biomass, and hydrogen generated by the electrolysis of water is included as a fuel gas for generating motive power along with the combustible gas, and the concentration of oxygen in the gasification agent is set to within a predetermined range, and thereby the inventors arrived at the present invention.

In particular, the present invention is achieved by the following means.

<1> A biomass gasification power generation system including: a gas generation device (gas generation means) that generates a combustible gas from a biomass and a gasification agent; an internal combustion engine that generates motive power from a fuel gas containing the combustible gas generated by the gas generation device; and a generator that generates electric power from the motive power generated by the internal combustion engine, wherein the power generation system is further provided with a water electrolysis device that generates oxygen and hydrogen through the electrolysis of water, the gasification agent contains oxygen generated by the water electrolysis device, the fuel gas contains hydrogen generated by the water electrolysis device, and the oxygen concentration in the gasification agent is from 22 vol. % to 40 vol. %.

<2> The biomass gasification power generation system according to <1>, further including: an oxygen supply device (oxygen supply means) that supplies oxygen generated by the water electrolysis device to the gas generation device; and a hydrogen supply device that supplies hydrogen generated by the water electrolysis device to the internal combustion engine.

<3> The biomass gasification power generation system according to <1> or <2>, wherein the biomass is a plant-derived biomass.

<4> The biomass gasification power generation system according to any one of <1> to <3>, wherein the plant-derived biomass includes at least one of woody biomass, herbaceous biomass, plant residue, and food scraps.

<5> The biomass gasification power generation system according to any one of <1> to <4>, wherein a water content in the biomass is not less than 10 mass %.

<6> The biomass gasification power generation system according to any one of <1> to <4>, wherein the water content in the biomass is from 10 mass % to 60 mass %.

<7> The biomass gasification power generation system according to any one of <1> to <6>, wherein a hydrogen concentration in the fuel gas is from 15 vol. % to 50 vol. %.

<8> A power generation method including: a gas generation step of generating a combustible gas from a biomass and a gasification agent; a motive power generation step of generating motive power from a fuel gas containing the combustible gas generated through the gas generation step; and an electric power generation step of generating electric power from the motive power generated through the motive power generation step; wherein the power generation method further includes a water electrolysis step of generating oxygen and hydrogen through the electrolysis of water, the gasification agent contains oxygen generated through the water electrolysis step, the fuel gas contains hydrogen generated through the water electrolysis step, and an oxygen concentration in the gasification agent is from 22 vol. % to 40 vol. %.

<9> The power generation method according to <8>, wherein the gas generation step is performed by a gas generation device, the motive power generation step is performed by an internal combustion engine; and the power generation method further includes an oxygen supply step of supplying oxygen generated through the water electrolysis step to the gas generation device, and a hydrogen supply step of supplying hydrogen generated through the water electrolysis step to the internal combustion engine.

<10> The power generation method according to <8> or <9>, wherein the biomass is a plant-derived biomass.

<11> The power generation method according to any one of <8> to <10>, wherein the plant-derived biomass includes at least one of woody biomass, herbaceous biomass, plant residue, and food scraps.

<12> The biomass gasification power generation system according to any one of <8> to <11>, wherein a water content in the biomass is not less than 10 mass %.

<13> The power generation method according to any one of <8> to <11>, wherein the water content in the biomass is from 10 mass % to 60 mass %.

<14> The power generation method according to any one of <8> to <13>, wherein a hydrogen concentration in the fuel gas is from 15 vol. % to 50 vol. %.

<15> The power generation method according to any one of <8> to <14>, using gasification power generation system described in any one of <1> to <7>.

The biomass gasification power generation system of the present invention is a power generation system including: a gas generation device (gas generating means) that generates a combustible gas from biomass and a gasification agent, an internal combustion engine that generates motive power from fuel gas containing the combustible gas generated by the gas generation device, and a generator that generates electric power from the motive power generated by the internal combustion engine. The power generation system further includes a water electrolysis device that generates oxygen and hydrogen through the electrolysis of water, the gasification agent contains oxygen generated by the water electrolysis device, and the fuel gas contains hydrogen generated by the water electrolysis device. The oxygen concentration in the gasification agent is from 22 vol. % to 40 vol. %.

The thermolysis gasification system described in Patent Document 1 requires that the carbonization treatment be performed at a high temperature of 300° C. or higher in order to allow the biomass to have optimal properties for gasification, and therefore a carbonization device is required. Thus, a problem with the thermolysis gasification system described in Patent Document 1 is that the overall system is large and complicated, and in addition thereto, the energy efficiency is insufficient because energy is consumed in the carbonization of the biomass. In contrast, the biomass gasification power generation system of the present invention is configured to include oxygen produced by a water electrolysis device as a gasification agent for producing a combustible gas from biomass. Through this, the biomass gasification power generation system of the present invention can stably gasify biomass without the need for a carbonization device, and as a result, the overall system can be miniaturized and simplified. Furthermore, the biomass gasification power generation system of the present invention uses the electrolysis of water to increase the oxygen concentration in the gasification agent, and thereby can reduce the nitrogen concentration in the gasification agent, and can improve the yield of combustible gas. In addition, with the thermolysis gasification system described in Patent Document 1, motive power is generated from the generated combustible gas, and the generator is driven using the generated motive power, but the motive power must be further improved in order to achieve practical applications as a power generation system. In contrast, the biomass gasification power generation system of the present invention is configured to include, as a fuel gas for generating motive power, hydrogen generated by the electrolysis of water, and thereby the motive power for driving the generator can be improved. Furthermore, the biomass gasification power generation system of the present invention includes, as the gasification agent, oxygen generated by the water electrolysis device, and thereby can efficiently generate a combustible gas from a biomass, and thus, for example, the generation of by-products such as tar can be suppressed.

Patent Document 1 also discloses that oxygen enriched air produced by a pressure swing adsorption device (PSA) may be introduced in order to increase the concentration of the combustible gas that is produced. A pressure swing adsorption device is a device that selectively collects a specific gas such as oxygen gas or hydrogen gas by repeatedly implementing adsorption by an adsorbent under high pressure conditions and desorption under low pressure conditions. Therefore, as in Patent Document 1, it is also conceivable to utilize a pressure swing adsorption device to increase the concentration of the combustible gas. However, a system that uses a pressure swing adsorption device requires that a plurality of adsorption tanks be provided to selectively collect the gas as described above, or that a buffer tank be provided to store the gas extracted by the adsorption tanks, and therefore it becomes difficult to support a compact design, which is a problem. A system that uses a pressure swing adsorption device (PSA) requires the preparation of two types of pressure swing adsorption devices, namely a pressure swing adsorption device for oxygen gas that selectively collects oxygen gas, and a pressure swing adsorption device for hydrogen gas that selectively collects hydrogen gas, leading to problems such as not only the inability to further support more compact designs, but also the cost of the overall system and insufficient production efficiency. In contrast, with the present invention, a water electrolysis device is used to increase the concentration of the combustible gas that is generated, and the size of the water electrolysis cell can be appropriately adjusted to support a more compact design of the water electrolysis device, and therefore, the overall biomass gasification power generation system can be made smaller. Furthermore, with the present invention, oxygen gas and hydrogen gas can be generated using the water electrolysis device, and there is no need to prepare separate devices for generating the oxygen gas and hydrogen gas, and therefore another merit of the present invention is that of excelling in cost and production efficiency.

With the biomass gasification power generation system of the present invention, the oxygen concentration in the gasification agent is from 22 vol. % to 40 vol. %. The reaction between the biomass gas and the gasification agent typically produces carbon monoxide, which is a combustible gas, through an oxidation reaction of hydrocarbons in the biomass gas with oxygen in the gasification agent. Thus, in the biomass gasification power generation system of the present invention, when the oxygen concentration in the gasification agent is more than or equal to 22 vol. %, the oxidation reaction described above is more likely to proceed, and the yield of combustible gas can be further improved. On the other hand, when the oxygen concentration in the gasification agent is more than or equal to 40 vol. %, the hydrocarbons in the biomass gas are more prone to undergo an oxidation reaction to produce carbon dioxide, which is a nonflammable gas, and the yield of combustible gas tends to be reduced. In addition, when the oxygen concentration in the gasification agent is not more than 40 vol. %, localized combustion in the gas generation device does not easily occur, and stable gasification can be achieved. As a result, by setting the oxygen concentration in the gasification agent to be within the above-mentioned range, the biomass gasification power generation system of the present invention can improve the yield of combustible gas, and can further improve the motive power for driving the generator.

The biomass gasification power generation system of the present invention is preferably further provided with an oxygen supply device (oxygen supply means) for supplying oxygen generated by the water electrolysis device to the gas generation device, and a hydrogen supply device (hydrogen supply means) for supplying hydrogen generated by the water electrolysis device to the internal combustion engine. By being provided with both the oxygen supply device and the hydrogen supply device, respectively, the biomass gasification power generation system of the present invention can stably supply both the hydrogen and oxygen generated by the water electrolysis device to the gas generating device and the internal combustion engine without any leakage of both, and therefore can further improve both the yield of the combustible gas, and the motive power for driving the generator.

Note that providing the oxygen supply device and the hydrogen supply device, respectively, means that a portion for supplying oxygen and a portion for supplying hydrogen are independent, and both may be independently disposed in the same device.

The water electrolysis device preferably uses electric power generated by a fluctuating power supply such as photovoltaic power generation or wind power generation to carry out the electrolysis of water. With the biomass gasification power generation system of the present invention, the water electrolysis device carries out the electrolysis of water using electric power generated by a fluctuating power supply, and thereby the amount of electric power that must be consumed externally for driving the water electrolysis device can be suppressed, and therefore the energy efficiency of the overall biomass gasification power generation system can be further improved. Furthermore, the electric power generated by the biomass gasification power generation system of the present invention is controllable, and therefore control power can be generated using the fluctuating electric power generated by the fluctuating power supply.

The biomass is preferably a plant-derived biomass. The biomass gasification power generation system of the present invention can further improve the yield of combustible gas when biomass derived from plants is used as the biomass.

The water content in the biomass is preferably not less than 10 mass %, and preferably not more than 60 mass %. When biomass having a high water content is used, due to the high water content, it is necessary to further increase the temperature of the reaction system in which the biomass and the gasification agent are reacted, and there is a risk that the temperature may decrease locally in the reaction system. In contrast, when the water content in the biomass used by the biomass gasification power generation system of the present invention is not more than 60 mass %, it is not necessary to excessively increase the temperature of the reaction system, and the reaction is likely to smoothly advance without localized decreases in temperature, and therefore both the energy efficiency of the overall system and the yield of combustible gas can be further improved. From the perspective of facilitating a smooth progression of the reaction described above, the water content in the biomass is preferably small, but this requires a complex processing step to remove moisture and thereby reduce the water content in the biomass as much as possible. However, in the biomass gasification power generation system of the present invention, even if the water content in the biomass is 10 mass % or higher, the reaction proceeds sufficiently and smoothly, and both the energy efficiency of the entire system and the yield of combustible gas can be further improved. Therefore, setting the water content in the biomass to at least 10 mass % is advantageous from the perspective of being able to reduce manufacturing costs without requiring a complex processing step.

Herein, the water content in the biomass is calculated based on the moisture criterion expressed by the following equation.

Water content (mass %)=X/Y×100

X: mass of water in biomass

Y: Mass of biomass

This water content is a value immediately before fed into the gas generation device, and is measured at 25° C.

The hydrogen concentration in the fuel gas is preferably not less than 15 vol. %, and preferably not more than 50 vol. %. In the biomass gasification power generation system of the present invention, motive power for driving the generator can be further improved when the hydrogen concentration in the fuel gas is set to more than or equal to 15 vol. %. On the other hand, combustion can be stably carried out by the internal combustion engine when the hydrogen concentration in the fuel gas is not more than 50 vol. %.

The power generation method of the present invention includes: a gas generation step of generating combustible gas from a biomass and a gasification agent, a motive power generation step of generating motive power from a fuel gas including the combustible gas generated in the gas generation step, and an electric power generation step of generating electric power from the motive power generated in the motive power generation step. The power generation method further includes a water electrolysis step of generating oxygen and hydrogen through the electrolysis of water, the gasification agent includes oxygen generated in the water electrolysis step, the fuel gas includes hydrogen generated in the water electrolysis step, and the oxygen concentration in the gasification agent is from 22 vol. % to 40 vol. %.

Note that the term “step” herein includes not only an independent step, but also a case in which the desired action of a step is achieved, though the step cannot be clearly differentiated from another step.

In addition, unless otherwise specified, the preferable ranges, etc. of the power generation method of the present invention are the same as those of the biomass gasification power generation system described above.

With the power generation method of the present invention, the biomass and the like can be stably gasified by adopting a configuration in which the oxygen produced in the water electrolysis step is included as a gasification agent for producing combustible gas from the biomass. Furthermore, with the biomass gasification power generation system of the present invention, by using water electrolysis to increase the oxygen concentration in the gasification agent, the nitrogen concentration in the gasification agent can be lowered, and the yield of combustible gas can be improved. This can suppress the amount of energy consumed compared to a method for subjecting biomass, etc. to a carbonization treatment at high temperatures, and therefore can improve the energy efficiency of the entire system. Furthermore, the biomass gasification power generation system of the present invention can improve the motive power for driving the generator by adopting a configuration in which the hydrogen generated through the electrolysis of water is included as a fuel gas for generating motive power.

With the power generation method of the present invention, the oxygen concentration in the gasification agent is from 22 vol. % to 40 vol. %. In the power generation method of the present invention, when the oxygen concentration in the gasification agent is more than or equal to 22 vol. %, the oxidation reaction will easily proceed, and the yield of combustible gas can be further improved. On the other hand, with the power generation method of the present invention, when the oxygen concentration in the gasification agent is not more than 40 vol. %, localized combustion in the gas generation device is unlikely to occur, and stable gasification can be achieved. Therefore, by setting the oxygen concentration in the gasification agent to be within the above-mentioned range, the power generation method of the present invention can improve the yield of combustible gas, and can further improve the motive power for driving the generator.

The gas generation step is preferably performed by a gas generation device, and the power generation step is preferably performed by an internal combustion engine. Additionally, the power generation method preferably further includes an oxygen supply step of supplying oxygen generated in the water electrolysis step to the gas generation device, and a hydrogen supply step of supplying hydrogen generated in the water electrolysis step to the internal combustion engine. With the power generation method of the present invention, by providing the oxygen supply step and the hydrogen supply step, respectively, the hydrogen and oxygen generated in the water electrolysis step can be stably supplied to the gas generation device and the internal combustion engine without any leakage thereof, and therefore both the yield of the combustible gas and the motive power for driving the generator can be further improved.

The water electrolysis step preferably uses electric power generated by a fluctuating power supply such as photovoltaic power generation or wind power generation to carry out the electrolysis of water. In the power generation method of the present invention, when the water electrolysis step uses electric power generated by a fluctuating power supply to carry out the electrolysis of water, the external power required for the water electrolysis can be suppressed, and therefore the energy efficiency of the entire power generation method can be further improved. In addition, the electric power generated by the biomass gasification power generation system of the present invention is controllable, and therefore control power can be generated using the fluctuating electric power generated by the fluctuating power supply.

The biomass is preferably a plant-derived biomass. When biomass derived from plants is used as the biomass, the power generation method of the present invention can further improve the yield of combustible gas.

The water content in the biomass is preferably not less than 10 mass %, and preferably not more than 60 mass %. With the power generation method of the present invention, when the water content in the biomass is not more than 60 mass %, it is not necessary to excessively increase the temperature of the reaction system, and the reaction is likely to smoothly advances without localized decreases in temperature, and therefore both the energy efficiency of the overall power generation method and the yield of combustible gas can be further improved. From the perspective of facilitating a smooth progression of the reaction described above, the water content in the biomass is preferably small, but a complex processing step to remove moisture and thereby reduce the water content in the biomass as much as possible is required. However, in the biomass gasification power generation system of the present invention, even if the water content in the biomass is 10 mass % or higher, the reaction proceeds sufficiently and smoothly, and both the energy efficiency of the entire system and the yield of combustible gas can be further improved. Therefore, setting the water content in the biomass to at least 10 mass % is advantageous from the perspective of being able to reduce manufacturing costs without requiring a complex processing step.

The hydrogen concentration in the fuel gas is preferably not less than 15 vol. %, and preferably not more than 50 vol. %. With the power generation method of the present invention, motive power for the electric power generation step can be further improved when the hydrogen concentration in the fuel gas is not less than 15 vol. %. On the other hand, the power generation method of the present invention can stably carry out combustion with the internal combustion engine when the hydrogen concentration in the fuel gas is not more than 50 vol. %.

The power generation method preferably uses the power generation system of the present invention.

### Advantageous Effects of Invention

According to the present invention, a power generation system and a power generation method that can improve the yield of combustible gas when producing combustible gas from biomass and can further improve motive power for driving a generator can be provided.

### BRIEF DESCRIPTION OF DRAWINGS

FIG. 1 is a schematic view illustrating an example of a configuration of a biomass gasification power generation system of the present invention.

### DESCRIPTION OF EMBODIMENTS

Hereinafter, embodiments for carrying out the present invention (hereinafter, referred to simply as “the present embodiment”) will be described. Note that the following present embodiments are examples for describing the present invention, and the present invention is not limited to the present embodiments.

### Biomass Gasification Power Generation System 1

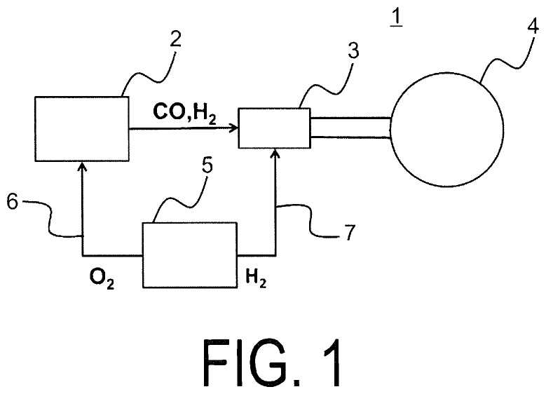

FIG. 1 is a schematic view illustrating an example of a configuration of a biomass gasification power generation system of the present embodiment. The biomass gasification power generation system 1 illustrated in FIG. 1 is provided with a gas generation device 2, an internal combustion engine 3, a generator 4, a water electrolysis device 5, an oxygen supply device 6, and a hydrogen supply device 7. The gas generation device 2 generates a combustible gas from a biomass and a gasification agent. The internal combustion engine 3 generates motive power from a fuel gas containing the combustible gas generated by the gas generation device 2. The generator 4 generates electric power from the motive power generated by the internal combustion engine 3. The water electrolysis device 5 generates oxygen and hydrogen through the electrolysis of water. The oxygen supply device 6 supplies the oxygen generated by the water electrolysis device 5 to the gas generation device 2. The hydrogen supply device 7 supplies the hydrogen generated by the water electrolysis device 5 to the internal combustion engine 3. Note that in the present embodiment, the oxygen supply device 6 and the hydrogen supply device 7 are any constituent elements.

### Gas Generation Device 2

The gas generation device 2 is not particularly limited as long as it is capable of generating a combustible gas from a biomass and a gasification agent. A specific example of the gas generation device 2 is preferably a gasification furnace. Examples of the types of gasification furnaces include a fixed bed type, a fluidized bed type, an entrained bed type, and a rotary kiln type gasification furnaces, and the type of gasification furnace is preferably a fixed bed type from the perspective of device cost and miniaturization. The fixed bed type is normally classified into a downdraft type in which the biomass and gasification agent flow in the same direction, and an updraft type in which the biomass and gasification agent flow in opposite directions, and the fixed bed type is preferably a downdraft type from the perspective of hardly producing by-products such as tar in the combustible gas.

A downdraft gasification furnace includes, for example, a thermolysis layer formed at an uppermost part inside the furnace, a combustion layer formed below the thermolysis layer, and a reduction layer formed below the combustion layer. In the thermolysis layer, the biomass is thermally decomposed to methane, carbon monoxide, carbon dioxide, hydrogen, water, char, tar, ash, and the like at a temperature from 200 to 600° C. In the combustion layer, the char, tar, hydrogen, carbon monoxide, and the like are oxidized to carbon monoxide, carbon dioxide, water, and the like at a temperature from 600 to 1300° C. In the reduction layer, at a temperature from 600 to 800° C., the char is reacted with carbon dioxide or water, and methane is reacted with water, and thereby combustible gases such as carbon monoxide and hydrogen are produced.

### Internal Combustion Engine 3

The internal combustion engine 3 is not particularly limited as long as it is capable of generating motive power from the fuel gas containing the combustible gas generated by the gas generation device 2. Specific examples of the internal combustion engine 3 include a gas engine, a gasoline engine, a diesel engine, and a gas turbine. The internal combustion engine 3 is provided with, for example, a rotating part connected to the generator 4 and a drive shaft for rotating the rotating part. The internal combustion engine 3 converts energy generated by combusting the fuel gas, into rotational energy of the drive shaft, and the generator 4 generates power through the rotation of the rotating part. The internal combustion engine 3 is also provided with, for example, an exhaust gas line, and the internal combustion engine 3 discharges, from the exhaust gas line, exhaust gas generated by the combustion of fuel gas.

### Generator 4

The generator 4 is not particularly limited as long as it is capable of generating electric power from the motive power generated by the internal combustion engine 3. The generator 4 is, for example, connected to the rotating part of the internal combustion engine 3, and generates power by the rotation of the rotating part due to the rotational energy generated by the internal combustion engine 3.

### Water Electrolysis Device 5

The water electrolysis device 5 is not particularly limited as long as it is a device capable of producing oxygen and hydrogen through the electrolysis of water. Examples of the water electrolysis device 5 include an alkaline water electrolysis device that electrolyzes water using an aqueous alkaline solution as an electrolyte, and a solid polymer water electrolysis device that electrolyzes water using an ion exchange membrane as an electrolyte, and for example, commercially available devices can be used as these devices. Among these, from the perspective of production efficiency, a solid polymer water electrolysis device is preferable. The solid polymer water electrolysis device may be provided with, for example, a water electrolysis cell, a water supply device (water supply means), a power supply device (power supply means), a first gas-liquid separation device (first gas-liquid separation means), and a second gas-liquid separation device (second gas-liquid separation means). The water electrolysis cell may be provided with, for example, a water electrolysis membrane having a solid polymer electrolyte membrane and metal electrodes formed on both sides of the solid polymer electrolyte membrane, and an anode chamber and a cathode chamber separated by the water electrolysis membrane. The water supply device supplies water to the water electrolysis cell, for example. The power supply device supplies electric power to the metal electrode of the water electrolysis membrane in the water electrolysis cell, for example. The first gas-liquid separation device separates, for example, a mixture of oxygen and water generated by the electrolysis of water in the anode chamber of the water electrolysis cell into oxygen gas and water. The second gas-liquid separation device separates, for example, a mixture of hydrogen and water generated by the electrolysis of water in the cathode chamber of the water electrolysis cell into hydrogen gas and pure water. When the solid polymer water electrolysis device is configured as described above, the oxygen gas generated in the anode chamber of the water electrolysis cell flows into the first gas-liquid separation device along with water, and the oxygen gas is separated from the water in a separation chamber of the first gas-liquid separation device and remains in an upper portion of the separation chamber.

Meanwhile, hydrogen gas produced in the cathode chamber of the water electrolysis cell flows into the second gas-liquid separation device along with water, and the hydrogen gas is separated from the water in a separation chamber of the second gas-liquid separation device and remains in an upper portion of the separation chamber. Here, water separated from oxygen gas or hydrogen gas in each gas-liquid separation device remains at a bottom side of each separation chamber and is discharged through a discharge valve. In this manner, the solid polymer water electrolysis device described above can extract oxygen and hydrogen with high purity from water.

### Oxygen Supply Device 6

The oxygen supply device 6 is not particularly limited as long as it can supply oxygen generated by the water electrolysis device 5 to the gas generation device 2. The oxygen supply device 6 may, for example, include a supply pipe that connects the water electrolysis device 5 and the gas generation device 2 and supplies oxygen generated by the water electrolysis device 5. The oxygen supply device 6 may be provided with, between the supply pipe and the water electrolysis device, a tank for storing oxygen. As necessary, the oxygen supply device 6 may also include: an on/off valve provided midway in the above-mentioned supply pipe to start or stop the supply of oxygen, a flow meter provided midway in the above-mentioned supply pipe to measure the flow rate of oxygen, and a control device for controlling the flow rate of oxygen based on the measured value obtained by the flow meter.

### Hydrogen Supply Device 7

The hydrogen supply device 7 is not particularly limited as long as it can supply the oxygen produced by the water electrolysis device 5 to the internal combustion engine 3. The hydrogen supply device 7 may, for example, include a supply pipe that connects the water electrolysis device 5 and the internal combustion engine 3 and supplies hydrogen generated by the water electrolysis device 5. The hydrogen supply device 7 may also be provided with, between the supply pipe and the water electrolysis device, a tank for storing hydrogen. As necessary, the hydrogen supply device 7 may also include: an on/off valve provided midway in the above-mentioned supply pipe to start or stop the supply of hydrogen, a flow meter provided midway in the above-mentioned supply pipe to measure the flow rate of hydrogen, and a control device for controlling the flow rate of hydrogen based on the measured value obtained by the flow meter.

### Power Generation Method

The power generation method of the present embodiment is carried out, for example, using a biomass gasification power generation system (biomass gasification power generation device) 1 illustrated in FIG. 1. However, the power generation method of the present embodiment is not limited to use of the biomass gasification power generation system (biomass gasification power generation device) 1 illustrated in FIG. 1. The power generation method of the present embodiment includes a gas generation step, a motive power generation step, an electric power generation step, a water electrolysis step, an oxygen supply step, and a hydrogen supply step. In the gas generation step, combustible gas is generated from a biomass and a gasification agent by, for example, the gas generation device 2. In the motive power generation step, for example, the internal combustion engine 3 is used to generate motive power from a fuel gas containing the combustible gas generated in the gas generation step. In the electric power generation step, for example, the generator 4 is used to generate electric power from the motive power generated in the motive power generation step. In the water electrolysis step, for example, the water electrolysis device 5 is used to generate oxygen and hydrogen through the electrolysis of water. In the oxygen supply step, for example, the oxygen supply means 6 is used to supply the oxygen generated in the water electrolysis step to the gas generation device 2. In the hydrogen supply step, for example, the hydrogen supply device 7 is used to supply hydrogen generated in the water electrolysis step to the internal combustion engine 3. Note that in the present embodiment, the oxygen supply step and the hydrogen supply step are any constituent elements.

The power generation method of the present embodiment first uses the water electrolysis device 5 to generate oxygen and hydrogen in the water electrolysis step. Next, in the oxygen supply step, the generated oxygen is supplied to the gas generation device 2 via the oxygen supply device 6, and thereby the generated oxygen is contained in the gasification agent for producing a combustible gas from the biomass. Next, in the gas generation step, the gas generation device 2 generates a combustible gas from the biomass and the gasification agent. Next, in the hydrogen supply step, the generated hydrogen is supplied to the internal combustion engine 3 through the hydrogen supply device 7, and thereby the generated hydrogen is contained in the fuel gas along with the combustible gas generated in the gas generation step. Next, in the motive power generation step, motive power is generated from the fuel gas by the internal combustion engine 3. Next, in the electric power generation step, motive power generated in the motive power generation step is used by the generator 4 to generate electric power.

In the power generation system and the power generation method of the present embodiment, the gasification agent includes oxygen generated by the water electrolysis device 5 (the water electrolysis step), and thereby the yield of combustible gas generated by the gas generation device 2 (gas generation step) can be improved. Furthermore, in the power generation system and the power generation method of the present embodiment, water electrolysis is used to increase the oxygen concentration in the gasification agent, and thereby the characteristics of the biomass and the like are optimized for gasification, and energy consumption can be suppressed compared to a method in which biomass and the like are subjected to a carbonizing treatment at high temperatures. Therefore, the energy efficiency of the entire system can also be improved. Furthermore, with the power generation system and the power generation method of the present embodiment, the motive power for driving the generator 4 can be improved by configuring the fuel gas to include the hydrogen generated by the water electrolysis device 5 (the water electrolysis step).

### Biomass

As the biomass used in the biomass gasification power generation system of the present embodiment, a renewable biomass that is a biologically-derived organic resource and excludes fossil resources can be widely adopted, and may be a plant-derived biomass or an animal-derived biomass. However, from the perspective of further improving the yield of the combustible gas, the biomass is preferably a plant-derived biomass. Examples of plant-derived biomasses include woody biomass such as cedar chips, cedar bark, and white pellets; herbaceous biomass such as bamboo, rice hulls, bagasse, beet pulp, wheat straw, corn stover, rice straw, and cassava dregs; plant residue such as fruit peels; and food scraps such as roasted coffee grounds, tea grounds, and wheat bran.

Biomass can also be classified into waste-based biomass, unused biomass, resource crops, and the like. Waste-based biomass includes waste paper, livestock excrement, food waste, construction wood scraps, sawmill scraps, sewage sludge, and the like; unused biomass includes rice straw, wheat straw, rice hulls, and the like; and resource crops include plants such as sugarcane and corn cultivated for the purpose of producing energy and products.

One type of these biomasses may be used alone, or two or more types may be used in combination.

The water content in the biomass is preferably not less than 10 mass %, and preferably not more than 60 mass %. When the water content in the biomass used by the biomass gasification power generation system and power generation method of the present invention is not more than 60 mass %, it is not necessary to excessively increase the temperature of the reaction system, and the reaction is likely to smoothly advance without localized decreases in temperature, and therefore the energy efficiency of the overall system or the entire process can be further improved, and the yield of combustible gas can be further increased. From the same perspective, the water content in the biomass is more preferably not less than 13 mass %, and even more preferably not less than 15 mass %. The water content in the biomass is also more preferably not more than 50 mass %, and even more preferably not more than 40 mass %.

### Gasification Agent

The gasification agent of the present embodiment includes oxygen generated by the water electrolysis device, and may optionally include an oxygen-containing gas from an external source. Examples of the oxygen-containing gas include air, oxygen enriched air, and pure oxygen. The gasification agent is an agent for gasifying biomass, and for example may be oxygen, air, or a mixture thereof, or may be an agent obtained by adding water vapor to oxygen, air, or a mixture thereof. In particular, the gasification agent is preferably such that the total of the oxygen, air, and water vapor accounts for at least 99 vol. % of the gasification agent.

As the method for supplying oxygen generated by water electrolysis to the gas generation device in the oxygen supply step described above, for example, the oxygen generated by the electrolysis of water may be supplied to the gas generation device simultaneously with an oxygen-containing gas from the outside, or the oxygen-containing gas from the outside may be supplied to the gas generation device, after which the oxygen concentration is adjusted to a predetermined concentration, and subsequently, the oxygen produced by the water electrolysis is supplied to the gas generation device.

The oxygen concentration in the gasification agent is from 22 vol. % to 40 vol. %. In the biomass gasification power generation system and the power generation method of the present embodiment, if the oxygen concentration in the gasification agent is 22 vol. % or higher, by-products such as tar are less likely to be produced, the oxidation reaction described above is more likely to proceed, and the yield of combustible gas can be further improved. On the other hand, when the oxygen concentration in the gasification agent is 40 vol. % or less, localized combustion in the gas generation device is unlikely to occur, and stable gasification can be achieved. From the same perspective, the oxygen concentration in the gasification agent is preferably not less than 24 vol. %, and more preferably not less than 26 vol. %. Furthermore, the oxygen concentration in the gasification agent is preferably not more than 35 vol. %, and more preferably not more than 30 vol. %.

Furthermore, the nitrogen concentration of the gasification agent is preferably not more than 76 vol .% and more preferably not more than 74 vol. %. With such a configuration, the yield of the combustible gas can be improved. Furthermore, the lower limit is preferably 65 vol. % or greater, and more preferably 70 vol. % or greater. With such a configuration, stable gasification can be achieved.

### Fuel Gas

The fuel gas of the present embodiment contains the combustible gas generated by the gas generation device and the hydrogen produced by the water electrolysis device. As necessary, a combustible gas may be supplied from the outside for the fuel gas. Herein, combustible gas refers to a gas that is combustible in the presence of oxygen, and examples include carbon monoxide and hydrogen.

The hydrogen concentration in the fuel gas is preferably not less than 15 vol. %, and preferably not more than 50 vol. %. In the biomass gasification power generation system and the power generation method of the present invention, when the hydrogen concentration in the fuel gas is more than or equal to 15 vol. %, the motive power for driving the generator can be further improved. On the other hand, when the hydrogen concentration in the fuel gas is not more than 50 vol. %, the fuel gas can be stably combusted in the internal combustion engine. From the same perspective, the hydrogen concentration in the fuel gas is more preferably not less than 17 vol. %, and even more preferably not less than 19 vol. %. Furthermore, the hydrogen concentration in the fuel gas is more preferably not more than 40 vol. %, and even more preferably not more than 30 vol. %.

In the present invention, the content of combustible gas (total amount of carbon monoxide and hydrogen) in the fuel gas can be set to 32 vol .% or higher, and can be set to 33 vol. % or higher. The upper limit is, for example, not more than 50 vol. %, and may be not more than 40 vol. %.

### MODIFIED EXAMPLE

In the biomass gasification power generation system of the present embodiment, preferably, the water electrolysis device uses electric power generated by a fluctuating power supply such as photovoltaic power generation or wind power generation to carry out the electrolysis of water. In this case, with the power generation method of the present embodiment, in the water electrolysis step, water electrolysis is preferably performed using electric power generated by a fluctuating power supply such as photovoltaic power generation or wind power generation. In the biomass gasification power generation system and the power generation method of the present embodiment, the water electrolysis device (water electrolysis step) uses electric power generated by a fluctuating power supply such as photovoltaic power generation or wind power generation to carry out the electrolysis of water, and thereby the amount of electric power that must be consumed externally for the electrolysis of water can be suppressed, and thus the energy efficiency of the entire biomass gasification power generation system or the entire process can be further improved.

### EXAMPLES

The present invention will be described more specifically hereinafter using examples, but the present invention is not limited to the following examples.

### Configuration of Biomass Gas Power Generation System

In the present example, a biomass gasification power generation system 1 illustrated in the schematic view of FIG. 1 was used. A commercially available product (“H2BOX” available from Kobelco Eco-Solutions Co., Ltd.) was used as the water electrolysis device.

### Reference Example 1

Cedar chips having a water content of 13 mass % on a wet weight basis were supplied to a downdraft type gasification furnace having an outer diameter of 10 cm and a height of 60 cm. Subsequently, air was supplied as a gasification agent to the gasification furnace at a supply rate of 80 L/min, and carbon monoxide and hydrogen, which are combustible gases, were produced. The oxygen concentration in the gasification agent was 21 vol. %. The generated amounts of carbon monoxide, hydrogen, and carbon dioxide that were produced were, with respect to the entire gas amount (total of the gasification agent and the combustible gas), 18.0 vol. %, 13.0 vol. %, and 13.0 vol. %, respectively, and the amount of combustible gas generated (total amount of carbon monoxide and hydrogen generated) was 31.0 vol %. The temperature of the gasification furnace was from 400 to 900° C. The gas composition was measured by gas chromatography (GC).

### Example 1

Carbon monoxide and hydrogen, which are combustible gases, were generated in the same manner as in Reference Example 1 with the exception that a gasification agent obtained by supplying air at a supply rate of 80 L/min with respect to a supply rate of 4 L/min of oxygen generated by the water electrolysis device (“H2BOX” available from Kobelco Eco-Solutions Co., Ltd.) was used and supplied to the gasification furnace. The oxygen concentration in the gasification agent was 24.8 vol. %. The generated amounts of carbon monoxide, hydrogen, and carbon dioxide that were produced were, with respect to the entire gas in the gasification furnace, 21.8 vol. %, 13.3 vol. %, and 13.6 vol. %, respectively, and the amount of combustible gas generated (total amount of carbon monoxide and hydrogen generated) was 35.1 vol. %.

### Example 2

Carbon monoxide and hydrogen, which are combustible gases, were produced in the same manner as in Example 1 with the exception that the oxygen supply rate was 8 L/min instead of 4 L/min. The oxygen concentration in the gasification agent was 28.2 vol. %. The generated amounts of carbon monoxide, hydrogen, and carbon dioxide that were produced were, with respect to the entire gas in the gasification furnace, 24.8 vol. %, 13.6 vol. %, and 14.6 vol. %, respectively, and the amount of combustible gas generated (total amount of carbon monoxide and hydrogen generated) was 38.4 vol. %.

### Example 3

Carbon monoxide and hydrogen, which are combustible gases, were produced in the same manner as in Example 1 with the exception that cedar chips having a water content of 40 mass % on a wet weight basis were supplied instead of the cedar chips of Reference Example 1, and 72 L/min of air and 8 L/min of oxygen were supplied as the gasification agent. The oxygen concentration in the gasification agent was 27.9 vol. %. The generated amounts of carbon monoxide, hydrogen, and carbon dioxide that were produced were, with respect to the entire gas in the gasification furnace, 18.4 vol. %, 18.3 vol. %, and 17.1 vol. %, respectively, and the amount of combustible gas generated (total amount of carbon monoxide and hydrogen generated) was 36.7 vol. %.

### Comparative Example 1

An attempt was made to produce carbon monoxide and hydrogen, which are combustible gases, in the same manner as in Reference Example 1 with the exception that cedar chips having a water content of 40 mass % on a wet weight basis were supplied, but it was not possible to continue gasification due to misfiring.

### Reference Example 2

Wood pellets (white pellets) having a water content of 8 mass % on a wet weight basis were supplied to a downdraft type gasification furnace having an outer diameter of 10 cm and a height of 60 cm. Subsequently, air was supplied as a gasification agent to the gasification furnace at a supply rate of 80 L/min, and carbon monoxide and hydrogen, which are combustible gases, were produced. The generation rate of combustible gas that was generated was 120 L/min, and the generated amounts of carbon monoxide and hydrogen that were produced were, with respect to the entire gas in the gasification furnace, 18.0 vol. % and 13 vol. %, respectively. The temperature of the gasification furnace was from 400 to 900° C.

The above-mentioned combustible gas was supplied as a fuel gas to a gas engine having an engine displacement of 290 cc to generate motive power. The hydrogen concentration in the fuel creating agent at this time was 13 vol. %. As a result, the rotational speed was 1806 rpm, the torque was 8.97 Nm, and the motive power (2π×torque×rotational speed/60) was 1.7 kW.

### Example 4

Motive power was generated in the same manner as in Reference Example 2 with the exception that a fuel gas (133 L/min, carbon monoxide 13.5 vol. %, hydrogen 19.5 vol. %) was obtained by adding the hydrogen generated by the water electrolysis device (“H2BOX” available from Kobelco Eco-Solutions Co., Ltd.) at a supply rate of 13 L/min through the hydrogen supply device to the combustible gas (120 L/min, carbon monoxide 18.0 vol. %, hydrogen 13 vol. %) obtained in the same manner as Reference Example 2, and the obtained fuel gas was supplied to the above-mentioned gas engine. As a result, the rotational speed was 1819 rpm, the torque was 10.45 Nm, and the motive power was 2.0 kW.

### REFERENCE SIGNS LIST

1 Biomass gasification power generation system
2 Gas generation device
3 Internal combustion engine
4 Generator
5 Water electrolysis device
6 Oxygen supply device
7 Hydrogen supply device

1. A biomass gasification power generation system comprising: a gas generation device that generates a combustible gas from a biomass and a gasification agent; an internal combustion engine that generates motive power from a fuel gas containing the combustible gas generated by the gas generation device; and a generator that generates electric power from the motive power generated by the internal combustion engine, wherein
the power generation system further comprises a water electrolysis device that generates oxygen and hydrogen through the electrolysis of water, the gasification agent comprises oxygen produced by the water electrolysis device, and the fuel gas comprises hydrogen produced by the water electrolysis device; and
an oxygen concentration in the gasification agent is from 22 vol. % to 40 vol. %.

2. The biomass gasification power generation system according to claim 1, further comprising: an oxygen supply device that supplies oxygen generated by the water electrolysis device to the gas generation device; and a hydrogen supply device that supplies hydrogen generated by the water electrolysis device to the internal combustion engine.

3. The biomass gasification power generation system according to claim 1, wherein the biomass is a plant-derived biomass.

4. The biomass gasification power generation system according to claim 1, wherein the plant-derived biomass comprises at least one of woody biomass, herbaceous biomass, plant residue, and food scraps.

5. The biomass gasification power generation system according to claim 1, wherein a water content in the biomass is not less than 10 mass %.

6. The biomass gasification power generation system according to claim 1, wherein the water content in the biomass is from 10 mass % to 60 mass %.

7. The biomass gasification power generation system according to claim 1, wherein a hydrogen concentration in the fuel gas is from 15 vol. % to 50 vol. %.

8. A power generation method comprising: a gas generation step of generating a combustible gas from a biomass and a gasification agent; a motive power generation step of generating motive power from a fuel gas comprising the combustible gas generated through the gas generation step; and an electric power generation step of generating electric power from the motive power generated through the motive power generation step; wherein
the power generation method further comprises a water electrolysis step of generating oxygen and hydrogen through the electrolysis of water, the gasification agent comprises oxygen generated through the water electrolysis step, the fuel gas comprises hydrogen generated through the water electrolysis step, and an oxygen concentration in the gasification agent is from 22 vol. % to 40 vol. %.

9. The power generation method according to claim 8, wherein the gas generation step is performed by a gas generation device, and the motive power generation step is performed by an internal combustion engine; and
the power generation method further comprises an oxygen supply step of supplying oxygen generated through the water electrolysis step to the gas generation device, and a hydrogen supply step of supplying hydrogen generated through the water electrolysis step to the internal combustion engine.

10. The power generation method according to claim 8, wherein the biomass is a plant-derived biomass.

11. The power generation method according to claim 8, wherein the plant-derived biomass comprises at least one of woody biomass, herbaceous biomass, plant residue, and food scraps.

12. The biomass gasification power generation system according to claim 8, wherein a water content in the biomass is not less than 10 mass %.

13. The power generation method according to claim 8, wherein a water content in the biomass is from 10 mass % to 60 mass %.

14. The power generation method according to claim 8, wherein a hydrogen concentration in the fuel gas is from 15 vol. % to 50 vol. %.

15. The power generation method according to claim 8, using a biomass gasification power generation system comprising:
a gas generation device that generates the combustible gas from the biomass and the gasification agent; an internal combustion engine that generates the motive power from the fuel gas containing the combustible gas generated by the gas generation device; and a generator that generates the electric power from the motive power generated by the internal combustion engine, wherein
the power generation system further comprises a water electrolysis device that generates oxygen and hydrogen through the electrolysis of water, the gasification agent comprises oxygen produced by the water electrolysis device, and the fuel gas comprises hydrogen produced by the water electrolysis device.
